(19) United States
(12) Patent Application Publication
(10) Pub. No.: US 2009/0085883 A1
(43) Pub. Date: Apr. 2, 2009

(54) Antiseptic touch panel and a method thereof

(75) Inventors: Tzu-Yi Gau, Taipei County (TW); Chia-Yen Li, Taipei County (TW); Chia-Chih Chang, Taipei County (TW)

Correspondence Address: Joe McKinney Muncy, PO Box 1364, Fairfax, VA, 22038-1364, US

(73) Assignee: DANOTECH CO., LTD.

(21) Appl. No.: 11/905,575

(22) Filed: Oct. 2, 2007

(51) Int. Cl. G06F 3/041; A01N 25/00

(52) U.S. Cl. 345/173; 422/35

(57) ABSTRACT

The present invention discloses an antiseptic touch panel comprising: a panel substrate, which is to be touch-operated by users; and an antiseptic layer coated on the panel substrate and having an antiseptic material with Formula (I):

(X₃Si)mR₁Zn, m≧1, n≧1 (I)

wherein X is a hydrolyzable silicon functional group and R₁ is an isocyanate group and Z is a quaternary ammonium salt group. The antiseptic touch panel of the present invention has a safe and persistent antiseptic effect because it has a plurality of silicon functional groups to promote the covalent bonding strength between the antiseptic material and the panel substrate and has a plurality of quaternary ammonium salt groups to enhance the antiseptic effect.

### FIELD OF THE INVENTION

The present invention relates to touch panel, particularly to an antiseptic touch panel.

### BACKGROUND OF THE INVENTION

A touch panel is an interface whereby a user can input signals or data into a computer directly from the panel, and wherein the areas touched by the user are transformed into electric signals input into the computer. In comparison with the traditional mice or keyboards, touch panels are much more user-friendly. Because of convenience and practicality, touch panels have been widely used in various products, including small-size portable electronic products and middle- or large-size industrial computers. A touch panel is an interface inputting data via touches. Especially, touch panels installed in a public place are frequently touched by many people and likely to be hotbeds for bacteria.

To solve the abovementioned problem, electronic manufacturers have applied antiseptic materials to the field of touch panels. Antiseptic materials include: antibiotics, inorganic antiseptic agents, organic antiseptic agents, etc., which are usually gradually released to kill bacteria. For example, a R.O.C. patent No. I 272110 disclosed a touch panel with an antiseptic layer and a method for fabricating the same, wherein metallic nanoparticles with a diameter of 1-100 nm are uniformly applied onto a panel to form an antiseptic layer. The metallic nanoparticles may be gold nanoparticles, silver nanoparticles, copper nanoparticles, zinc nanoparticles, platinum nanoparticles or a compound thereof. These metallic nanoparticles have biochemical activity and can penetrate the cell walls of bacteria to denature the enzymes inside the cells and kill bacteria. The working time of the gradual-release antiseptic agents can be prolonged via adjusting the concentration thereof or via decreasing the releasing speed thereof. However, such an antiseptic agent will be exhausted in the long run. Besides, the released antiseptic agent may be harmful to human beings or the environment.

A U.S. Pat. No. 6,504,583 utilizes a derivative of an alkyl quaternary ammonium salt as an antiseptic agent for touch panels. Alkyl quaternary ammonium salts have positive charges, and the electric balance of the bacterium cell membranes will be destroyed when the positive charges contact the negative-charged bacterium cell surfaces. Thus, the cell organs neighboring the cell membranes cannot perform metabolism, or even the cytoplasm leaks out because the cell membranes break. In comparison with the abovementioned metallic antiseptic agents, alkyl quaternary ammonium salts do not directly kill bacteria but function as a catalyst for destroying electric balance of cells. Therefore, alkyl quaternary ammonium salts will not be consumed but will maintain their concentrations. However, the antiseptic agent used by the U.S. Pat. No. 6,504,583 has a limited effect and an inferior adhesion. During service, this type of antiseptic agents is likely to be worn away or peeled off. Thus, the effect of this type of antiseptic agents will be attenuated with increasing service time.

### SUMMARY OF THE INVENTION

The primary objective of the present invention is to provide a touch panel with a persistent antiseptic effect, wherein less antiseptic agent will be worn out or peeled off during service, and wherein the antiseptic agent will not be released to harm human beings or contaminate the environment. To achieve the abovementioned objective, the present invention proposes an antiseptic touch panel comprising: a panel substrate, which is to be touch-operated by users, and an antiseptic layer coated on the panel substrate. The antiseptic layer has an antiseptic material with Formula (I):

(X₃Si)mR₁Zn, m≧1, n≧1 (I)

wherein X is a hydrolyzable silicon functional group and R₁ is an isocyanate group and Z is a quaternary ammonium salt group. Covalent bonds will form between the silicon functional group and an inorganic surface. Thus, the antiseptic material can stably and firmly stick to the inorganic material. The quaternary ammonium salt group provides an antiseptic effect. Thereby, the touch panel of the present invention can have a persistent antiseptic function. Further, the quaternary ammonium salt will not be released to harm human beings or contaminate the environment. Because of the silane groups, which can stick to an inorganic material, the multi-quaternary ammonium salt group antiseptic material with Formula (I) have a higher adhesion to a touch panel and a better antiseptic effect than the traditional quaternary ammonium salt antiseptic agents.

Another objective of the present invention is to simply the process of fabricating an antiseptic touch panel and to make an antiseptic material firmly stick to the touch panel. To achieve the abovementioned objective, the present invention proposes a method for fabricating an antiseptic touch panel comprising steps: diluting an antiseptic material with Formula (I); uniformly coating the antiseptic material with Formula (I) on a panel substrate; and sticking the antiseptic material with Formula (I) to the panel substrate, wherein sticking the antiseptic material with Formula (I) to the panel substrate may be realized via heating the coated antiseptic material with Formula (I) at a temperature of between 100 and 180° C. for at least one minute or placing the coated antiseptic material with Formula (I) at an ambient temperature for at least ten hours. The abovementioned simple method can stably stick the antiseptic material to a touch panel and can greatly reduce the fabrication cost and time.

### BRIEF DESCRIPTION OF THE DRAWINGS

FIG. 1 is a flowchart of a method according to a preferred embodiment of the present invention.

FIG. 2 is a flowchart of a method according to another preferred embodiment of the present invention.

### DETAILED DESCRIPTION OF THE PREFERRED EMBODIMENTS

The present invention discloses an antiseptic touch panel comprising: a panel substrate, which is to be touch-operated by users, and an antiseptic layer coated on the panel substrate. The panel substrate may be made of an organic material, such as a PET (Poly Ethylene Terephthalate) film, or an inorganic material, such as a glass. However, the present invention does not limit the material of the panel substrate. The antiseptic layer has an antiseptic material with Formula (I):

(X₃Si)mR₁Zn, m≧1, n≧1 (I)

wherein X is a hydrolyzable silicon functional group and R₁ is an isocyanate group and Z is a quaternary ammonium salt group. The silicon functional group is selected from a group consisting of halogens, alkoxy group and hydroxyl group.

The quaternary ammonium salt group in Formula (I) is to destroy the electric balance on the surfaces of bacteria or microbes and enable the antiseptic material to kill bacteria or microbes. As the quaternary ammonium salt group does not kill bacteria or microbes via penetrating the surfaces of bacteria or microbes, it will not be consumed with increasing service time. As the silicon functional group enables covalent bonds to form between the antiseptic material and the panel substrate, the antiseptic layer is hard to peel off from the panel substrate. Therefore, the antiseptic effect of the antiseptic touch panel of the present invention will not degrade after a long service time. In comparison with the traditional antiseptic agents having only a single quaternary ammonium salt group, the antiseptic material with Formula (I) has a better stickiness to the applied surface and a superior antiseptic effect because it has a plurality of silicon functional groups to enhance the bonding strength to an applied surface and has a plurality of quaternary ammonium salt groups to promote the antiseptic effect. Therefore, the antiseptic touch panel of the present invention has a persistent antiseptic effect.

The present invention also proposes a method for fabricating an antiseptic touch panel having an antiseptic material with Formula (I), which comprises steps: diluting an antiseptic material with Formula (I); uniformly coating the antiseptic material with Formula (I) on a panel substrate; and sticking the antiseptic material with Formula (I) to the panel substrate, wherein the antiseptic material is diluted to a concentration of 0.5%, and wherein the reaction of sticking the antiseptic material with Formula (I) to the panel substrate may be accelerated via heating the panel substrate coated with the antiseptic material with Formula (I) or placing the panel substrate coated with the antiseptic material with Formula (I) at an ambient temperature for air drying.

The embodiments of the method of the present invention and the antiseptic effect thereof will be described in detail below.

### Embodiment I

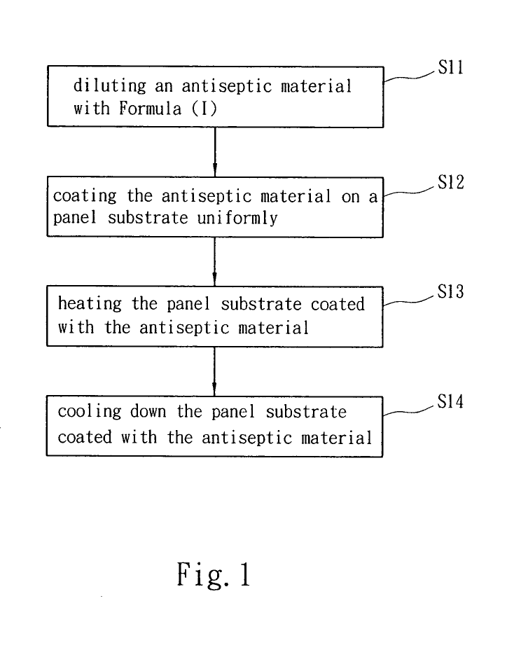

Refer to FIG. 1 a flowchart of a method according to a preferred embodiment of the present invention. In Step S11, 0.5% (w/w) of an antiseptic material with Formula (I) and 1% (w/w) of water are added into 98.5% (w/w) of ethanol; the mixture solution is mechanically agitated (such as with an agitator) until a homogeneous solution is obtained. In Step S12, the diluted homogeneous solution of the antiseptic material with Formula (I) is uniformly coated on a panel substrate. In this embodiment, the homogeneous antiseptic solution is sprayed on the panel substrate, and then the antiseptic material is made uniformly adhere to the panel substrate via swabbing the antiseptic solution with a soft cloth. However, the present invention does not limit the method to uniformly coat the antiseptic material on the panel substrate. Coating the antiseptic material may also be realized with a smearing method or a soaking method. In Step S13, the panel substrate coated with the antiseptic material is heated at a temperature of between 100 and 180° C. for at least one minute to volatilize water and ethanol in the antiseptic solution to accelerate the formation of covalent bonds between the antiseptic material and the panel substrate and make the antiseptic material firmly stick to the panel substrate. In Step S14, the touch panel is cooled down.

### Embodiment II

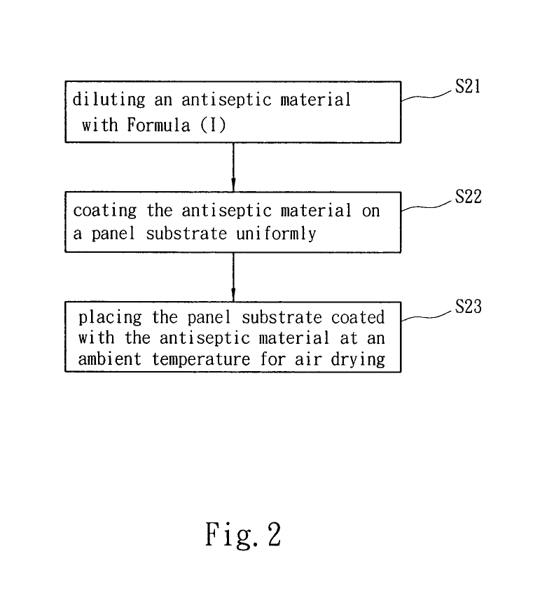

Refer to FIG. 2 a flowchart of a method according to another preferred embodiment of the present invention. In Step S21, 0.5% (w/w) of an antiseptic material with Formula (I) and 1% (w/w) of water are added into 98.5% (w/w) of ethanol; the mixture solution is mechanically agitated until a homogeneous solution is obtained. In Step S22, the diluted homogeneous solution of the antiseptic material with Formula (I) is uniformly coated on a panel substrate. In this embodiment, the homogeneous antiseptic solution is sprayed on the panel substrate, and then the antiseptic material is made uniformly adhere to the panel substrate via swabbing the antiseptic solution with a soft cloth. However, coating the antiseptic material may also be realized with a smearing method or a soaking method. In Step S23, the panel substrate coated with the antiseptic material is placed at an ambient temperature and air-dried for at least ten hours, until water and ethanol in the antiseptic solution is completely volatilized, to make the antiseptic material firmly stick to the panel substrate.

### Embodiment III

Escherichia coli (a Gram positive bacterium) is used in tests for verifying the antiseptic effect of the antiseptic touch panel of the present invention. Pieces of ITO (Indium Tin Oxide) conductive glass plates (each has a five square centimeters area) are coated with the antiseptic material with Formula (I). Pieces of the same ITO conductive glass plates are uncoated. 10⁴ Escherichia coli are uniformly applied to each piece of the coated and uncoated ITO conductive glass plates. All the Escherichia coli-bearing ITO conductive glass plates are incubated at a temperature of 37° C. for 24 hours. After incubation, all the ITO conductive glass plates are flushed with a sterile phosphate buffer to remove dead Escherichia coli. The number of the living Escherichia coli remaining on each ITO conductive glass plate is estimated. The results are that only less than 0.0001% Escherichia coli survive on the ITO conductive glass plates coated with the antiseptic material with Formula (I), and that over 10% Escherichia coli survive on the uncoated ITO conductive glass plates. In other words, the antiseptic effect of the ITO conductive glass plates coated with the antiseptic material with Formula (I) is 10 times higher than that of the uncoated ITO conductive glass plates.

In conclusion, the present invention proposes an antiseptic touch panel, which adopts an antiseptic material with Formula (I). The antiseptic material with Formula (I) has a plurality of quaternary ammonium salt groups to upgrade the antiseptic effect and has a plurality of silicon functional groups to promote the covalent bonding strength between the antiseptic material and the panel substrate. Thus, the antiseptic touch panel of the present invention has a persistent antiseptic effect. Therefore, the present invention indeed possesses novelty and non-obviousness and meets the conditions for a patent. Accordingly, the Inventor files the patent application for the present invention. It will be greatly appreciated that the patent is approved fast.

The present invention has been described in detail above. However, those described above are only the preferred embodiments to exemplify the present invention but not to limit the scope of the present invention. Any equivalent modification or variation according to the spirit of the present invention is to be also included within the scope of the present invention.

What is claimed is:

1. An antiseptic touch panel comprising:
a panel substrate, which is to be touch-operated by users;
an antiseptic layer coated on said panel substrate and having
an antiseptic material with Formula (I):
(X₃Si)mR₁Zn, m≧1, n≧1 (I)
wherein X is a hydrolyzable silicon functional group, and R₁ is an isocyanate group, and Z is a quaternary ammonium salt group.

2. The antiseptic touch panel according to claim 1, wherein said hydrolyzable silicon functional group is selected from a group consisting of halogens, alkoxy group and hydroxyl group.

3. A method for fabricating an antiseptic touch panel having an antiseptic material with Formula (I) in claim 1 comprising steps:
diluting an antiseptic material with Formula (I);
uniformly coating said antiseptic material with Formula (I) on a panel substrate; and
sticking said antiseptic material with Formula (I) to said panel substrate.

4. The method for fabricating the antiseptic touch panel according to claim 3, wherein said antiseptic material is diluted to a concentration of 0.5%.

5. The method for fabricating the antiseptic touch panel according to claim 3, wherein sticking said antiseptic material with Formula (I) to said panel substrate is realized via heating said panel substrate coated with said antiseptic material with Formula (I) at a temperature of between 100 and 180° C. for at least one minute.

6. The method for fabricating the antiseptic touch panel according to claim 3, wherein sticking said antiseptic material with Formula (I) to said panel substrate is realized via placing said panel substrate coated with said antiseptic material with Formula (I) at an ambient temperature for at least 10 hours.
